(19) United States
(12) Patent Application Publication
(10) Pub. No.: US 2004/0187457 A1
(43) Pub. Date: Sep. 30, 2004

(54) Robotic lawnmower

(76) Inventor: Andre Colens, Rixensart (BE)

Correspondence Address: Robert M Gamson, Armstrong Kratz Quintos Hanson & Brooks, Suite 220, 502 Washington Avenue, Towson, MD, 21204, US

(21) Appl. No.: 10/479,378

(22) PCT Filed: May 28, 2002
(86) PCT No.: PCT/BE02/00086

(30) Foreign Application Priority Data
May 28, 2001 (BE) 2001361

(51) Int. Cl. A01D 1/00

(52) U.S. Cl. 56/1

(57) ABSTRACT

The invention relates to a robotic machine which can move on a lawn, said machine being equipped with a device consisting of a series of elements (4,5). The ends of said elements are capable of touching and rectifying and/or cutting the flat blades of grass of the lawn. The machine will generally be a robotic lawnmower equipped with said device. The elements (4,5) will be advantageously flexible and arranged in tandem under the chassis of the machine. Said elements can be helicoidal springs (5). One end of said spring is fixed to the chassis using a strut, and the other end is rectified in the spring axis. The invention can further relate to articulated elements which cut in the direction of movement of the machine.

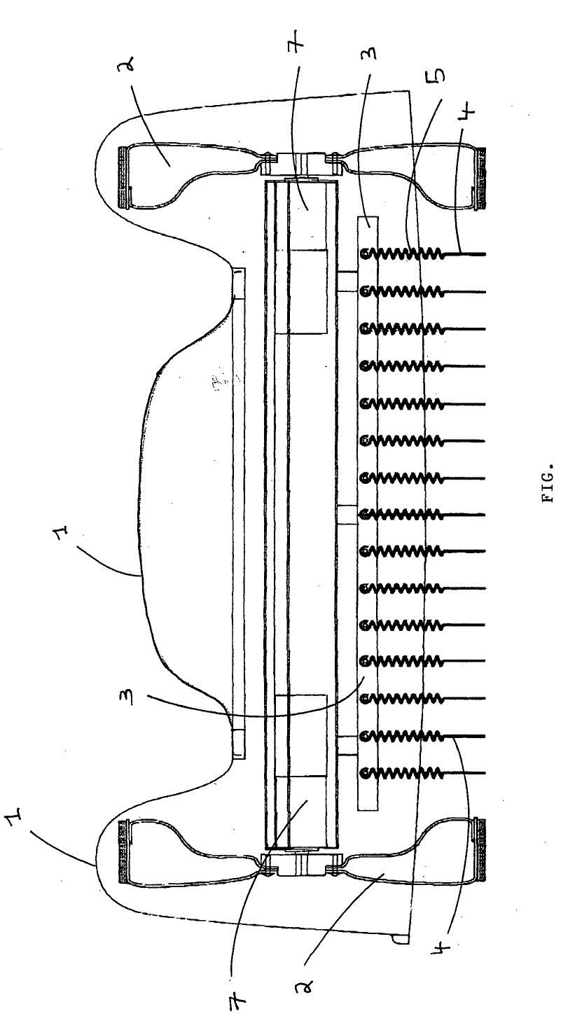

Low power robotic lawnmower that operates continually or almost continually as described in patents or applications for patents EP 0 550 473 B1, WO 98/41081, WO 00/60921 have advantages well-known today: safety, light weight, absence of noise, absence of cut grass collection, low manufacturing costs.

However, these lawnmowers do have a disadvantage due to their low power and, thus, their repeated passage over a given spot on the lawn. This disadvantage consists of crushing the grass and a tendency for the grass to grow horizontally.

Traditional, more powerful rotary lawnmowers create a suction effect that straightens the blades of grass while cutting.

On the other hand, cylindrical lawnmowers have helicoidal blades that straighten the grass by their rotating movement before shearing it against the cutting blade.

Another disadvantage met with robotic lawnmowers consist in the gradual formation of a layer of cut grass forming a carpet, which will produce later a layer of moss.

There has been noted also, associated or not with the latter phenomena, the possibility of grass growing horizontally which therefore cannot be cut by the robotic lawnmower.

The first approach consisted of optimizing the cutting device by adjusting the length of the blades, the space between the cutting disk and the protective lower disk, the inclination of the cutting head, as well as the shape of the lower protective disk.

These measures improved results without totally solving the problem.

The purpose of the present invention is to correct the defect mentioned in robotic lawnmowers by taking advantage of their frequent passage.

According to the invention, there is provided a solution that proved very effective consisting of adding a series of flexible elements to the mobile robot machine, the ends of which brush against the lawn surface.

The immediate effect is not very visible but the continual operation of the mobile device, combined with the random path, or in any case a path that frequently changes direction, means that the blades of grass are gradually straightened.

The flexible components can consist of elements in steel wire arranged in line, preferably transversely to the movement of the machine, located under the chassis of the machine.

The flexible elements can take other forms, however, suitable for brushing against and straightening flattened blades of grass. They can consist of flexible plastic rods.

The elements will be sharp or not. In the former case the cutting action will be in the direction of the movement of the machine. The invention provides in that way a more effective solution against the development of a layer of organic felt or of a mossy bed, as well as against the development of grass growing horizontally.

According to a particular arrangement, the elements are in the form of thin sharp plates articulated in a plane essentially parallel to the direction of movement of the machine.

A particularly effective arrangement uses a series of helicoidal springs one end of which is fastened to the chassis and the other rectified in the spring axis; the spring provides elasticity in the vertical direction, preventing any loss of adhesion of the machine for terrains that are not perfectly flat.

This arrangement is illustrated in the attached figure showing a transversal section of a robotic lawnmower with a device for carrying out the invention that it is mounted behind the cutting device.

There is to be noted body 1, driving wheels 2 and associated motor 7, a strut 3 mounted transversely carrying a series (15 in this case) of vertical rods 4 down to ground level, each rod being attached by means of a helicoidal spring 5 to the transversal strut 3.

There will be noted that the invention may apply to robotic machines other than lawnmowers. It can, for example, apply to robotic golf ball collectors as described in application WO 00/78410.

The machine can support or tow the arrangement containing the flexible or articulated elements. The arrangement according to the invention may be independent, and may be separated or attached at will to a robotic machine, for example as a trailer device.

Finally the robotic machine may have as only purpose to support the arrangement according to the invention.

1. Robotic machine intended to move on a lawn characterized by its being equipped with a series of elements the extremities of which are suitable for straightening blades of grass flattened in the lawn.

2. Robotic machine according of claim 1 characterized in that the machine is a robotic lawnmower.

3. Robotic machine according to claim 2 characterized in that it is equipped with a series of elements which extremities are adapted to brush and straighten, simultaneously at a mowing operation, the grass blades flattened on the lawn.

4. Robotic device according to claim 1 wherein the elements are flexible elements.

5. Robotic device according to claim 1 wherein the elements are arranged in a line under a chassis of the machine.

6. Robotic device according to claim 1 wherein the elements are made of steel wires mounted vertically.

7. Robotic device according to claim 1 wherein the elements are helicoidal springs one end of which is attached t the chassis by a strut and the other end of which is rectified along the spring axis.

8. Robotic device according to claim 1 in which the elements are non-cutting elements.

9. Robotic device according to claim 1 in which the elements are cutting elements.

10. Robotic device according to claim 9 wherein the element are cutting in the direction of displacement.

11. Robotic device according to claim 1 the elements are in the form of thin sharp plates articulated in a plane essentially parallel to the direction of displacement of the machine.

12. Robotic lawnmower according to claim 2 wherein the flexible or articulated elements being located behind the cutting head and/or heads with regard to the direction of displacement.

13. Machine according to claim 1 which is intended for the automatic collection of objects.

14. Machine according to claim 1 which is intended for the automatic collection of golf balls.
